(19) United States
(12) Patent Application Publication
(10) Pub. No.: US 2017/0004670 A1
(43) Pub. Date: Jan. 5, 2017

(54) SYSTEM AND METHOD FOR GENERATING SPORT BETTING CONSENSUS BASED ONTHE ABILITY OF HANDICAPPERS

(71) Applicant: Michael Klarman, Turnerville, NJ (US)

(72) Inventor: Michael Klarman, Turnerville, NJ (US)

(21) Appl. No.: 14/790,717

(22) Filed: Jul. 2, 2015

(51) Int. Cl. G07F 17/32; G06Q 50/34

(52) U.S. Cl. CPC G07F 17/326; G07F 17/3288; G06Q 50/34

(57) ABSTRACT

The present invention relates to a system and method for assessing the ability of sport bettors that are entering picks into a Handicapping Tracker Software and using these opinions to generate a general public consensus. The handicapper's ability is tagged in one hundred and twenty-seven different handicapping categories and the Handicapper gets tagged with one of the five different ability ranges. Bettors who view the general public consensus have the ability to use search, sort, and filter features, which allows them to separate the general public consensus of a game into fifteen sub-set consensuses called isolation consensuses. While viewing these sub-set consensuses the user adds certain weightage to the opinions contained within the general public consensus. Furthermore, the system calculates results for all opinion and conclusion picks made by the handicapper and display them side by side using the same set of one hundred and twenty-seven different handicapping categories.

### FIELD OF THE INVENTION

The present invention generally relates to generating a sports betting consensus that can be filtered into fifteen different sub-set consensus based on the ability of the handicappers making the selections and more particularly relates to a consensus that allows users to isolate pockets of sports handicappers, within the betting pool, based on their ability under three different filters that each display five different groups of ability for each game.

### BACKGROUND OF THE INVENTION

There are many sites that display a sports betting consensus, but the websites show a solitary two team distribution where every single bettor in the pool is lumped together and there is no way to separate the bettors by ability. Taking into account an ‘ability factor’ of those donating their opinions, will allow users to ‘weigh’ the opinion based upon the quality of handicapper making it. In fact, without an ability factor any sports betting consensus can be considered as a tool of deception by the house, which is why the current model in the marketplace licenses betting information from sports books that they can display in a simple consensus format. Handicappers have questions of validity, accuracy, and honesty in the current market.

Hence, there is an absolute need for a consensus that allows for search, sort, and filter features based on various ability statistics held by the handicappers in the betting pool. These features will allow the handicapper using the tool to add weight to the various opinions held within each game's consensus. Providing a vehicle for a ‘weightage factor’ that can be applied by the tool's user converts the sports betting consensus from a tool of deception for the house into a tool of clarity for the handicapper. Without supplying a way for the handicapper to weigh the information held within the consensus, the website can cause more harm than good for the handicapper.

### SUMMARY OF THE INVENTION

The present invention relates to a system and method for generating a sports betting consensus that can be searched and sorted based on the ability of the handicapper making the selection. The system allows the user to enter the opinion into the handicapping tracker software. All statistics and results are logged into a detailed profile that includes one hundred and twenty-seven different handicapping statistics calculated for every user. Further, the system filters each of the handicapper's opinion entered into the handicapping tracker software and tags the filters as follows: Overall rating (provides one overall rating), Rating in each game (considering six different games), Rating for 20 different game categories for each of the six games (providing 120 ratings). Further, the system supports a sorter for five different isolation groups, which then can be searched for and then have a sub-set consensus generated for just that isolated group. An isolation group is defined by a starting range and an ending range to the handicappers winning percentage in all the three categories: an overall category, a particular game category, or in a certain game situation, which makes a total of fifteen subset ability based consensus that the user can retrieve through a search bar on the web page, for each game. Further, the system places every consensus the handicappers are a part of in the proper isolation group for each of the three filters. Furthermore, the tool also captures the ‘conclusion’ selections by the handicapper, which will be the handicapping decision as per the selection opted by the users and concluded by the tool. The system provides one hundred and twenty-seven handicapping percentages on the handicapper's conclusion picks as shown for the opinion picks. Furthermore, the system displays the opinion and conclusion statistics side by side in the user's profile to compare how the handicappers perform in the various handicapping categories based on the user's opinion, and the conclusions made after using the tool.

### BRIEF DESCRIPTION OF DRAWINGS

FIG. 1 illustrates a working overview of the system 100 used to implement the method for assessing the ability of the handicappers to offer an opinion to a sports betting consensus within a network 101.

FIG. 2 illustrates a flow-chart 200 that explains the process of implementing the method for assessing the ability of each handicapper and determining the consensus of the game for the sport bettor(s) that can be searched and sorted by ability.

FIG. 3 illustrates the mode in which the opinions entered into the Handicapping tracker software 102 are turned into a plurality of consensus to be viewed by the sports bettor.

FIG. 4 illustrates a working overview of how the plurality of betting attributes is scored for each individual handicapper using an attribute analyzing software.

FIG. 5 illustrates a system overview of components 500 used to implement the method for assessing the ability of the handicappers and determining the consensus of the game for the sport bettor(s) within the network 101.

### FIGURE DESCRIPTION

100—A system overview
101—A network for implementing the method
102—A handicapping tracker software
103—Sports bettor(s)
104—Assessment ability range outliner associated with a website
105—Betting attributes analyzer associated with a website
106—Consensus results
200—A process that explains the method of displaying the sport betting consensus
500—A system overview of components used for implementing the method
501—A Registration module
502—A Display Interface module
503—An Ability assessment range module
504—A Betting attributes analyzer module
505—A Handicapper tracking software module
506—A Payment gateway module
507—A Communication module
508—A Controlling module

### DETAILED DESCRIPTION OF THE INVENTION

The following detailed description of the preferred embodiments presents a description of certain specific embodiments to assist in understanding the claims. However, the present invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be evident to one of ordinary skill in the art that the present invention may be practiced without these specific details.

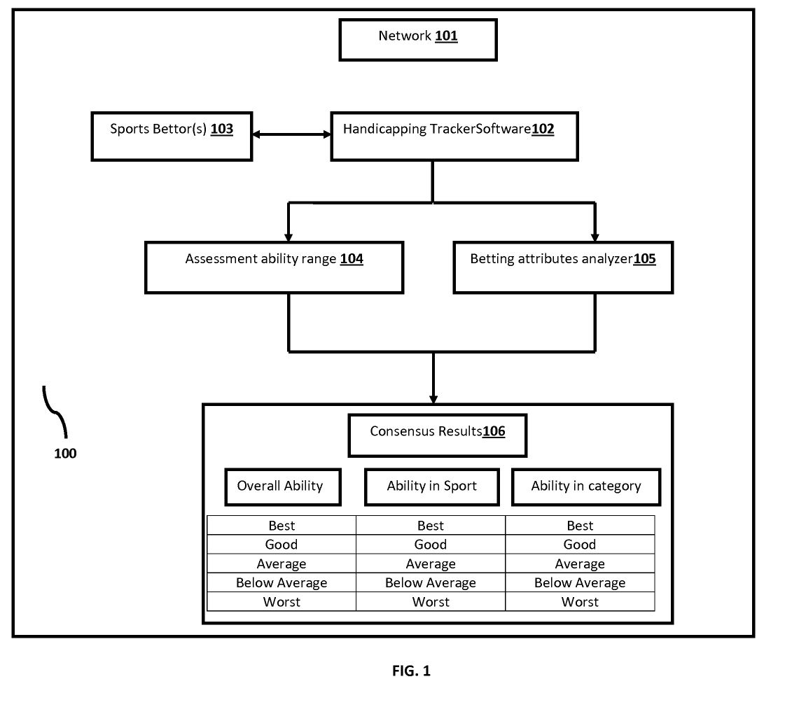

Referring to FIG. 1 illustrates a working overview of the system 100 used to implement the method for assessing the ability of handicappers to offer an opinion to a sport betting consensus within the network 101. In an embodiment, the sport bettor(s) is/are configured to register with free handicapping tracker software 102. In an embodiment, the software 102 tracks a plurality of opinion across six different sports and records a plurality of results for each bettor. Further, when the sports betting consensus is generated from the opinions entered into the software 102, each handicapper in each of the game consensus(es) can be tagged to be in one of the five ability rating categories for three different filters: Overall, Sport, Game Category. For example, tool user ABC has a choice of selecting X or Y team in a given game, and the user chooses X team. Further, the user will be grouped according to the overall handicapping record determined across all six sports and also grouped according to the team X category. The user can fall into the same group for each filter or fall into three separate consensuses, one based on an overall handicapping rating, one based on the sport, and another based on the particular game situation. Based on the inputs provided by the sports bettors, the opinions are funneled through the handicapping tracker software 102, and the software 102 allows the viewer to tag the handicapper(s) taking part in the consensus. Further, each of the handicapper's opinion is tagged in three different ways: Overall, by Sport, and by Game Category. The handicapper will earn one of the five ability rating for each of the three filters for every opinion they enter. For example, User ABC may have an overall winning percentage of 52% across all six sports, that would rate the ability as Average overall, but in the NFL if the user has a 55% winning percentage, that would provide him a Good rating in this sport, and the user may have a 58% winning percentage in a particular NFL game situation, which would make him/her the BEST under that game's filter for game situation.

In an embodiment, an interface with the handicapping tracker software 102 displays to the user a breakdown of one hundred and twenty seven different handicapping statistics. The statistics depicts the handicapper(s) strengths and weaknesses. Furthermore, the system tags each user with one of the five ratings for each of the three filters under which the betting pool can be sorted. This allows all the handicappers to be grouped with their peers according to a particular statistic drawn from all journals from all the handicappers participating in the game's consensus.

In an embodiment, a web interface associated with the Handicapping tracker software 102 is configured to display the winning percentages of the handicapper in 127 different categories and then tag that handicapper as one of the five ability ratings in each category. Further, the handicapper can be properly sorted based on the entered opinion.

In an embodiment, the web interface associated with the Handicapping tracker software 102 is configured to display a separate grid interface for displaying the opinion statistics and displaying the consensus statistics determined based on the opinion inputs.

In an embodiment, the web interface associated with the Handicapping tracker software 102 is configured to display the number of bettors that appear in each of the five ratings across the three filters in every game. It also can display a sub-set of consensus that takes into account only the isolated group that is being examined in a particular game. These isolated groups are determined by the handicapper's personal ability determined across the three filters: Overall, by sport, and by game category. Users will also get to see the personal statistics laid out over one hundred and twenty-seven different handicapping categories, which depicts the strengths and weaknesses of the bettors within the art.

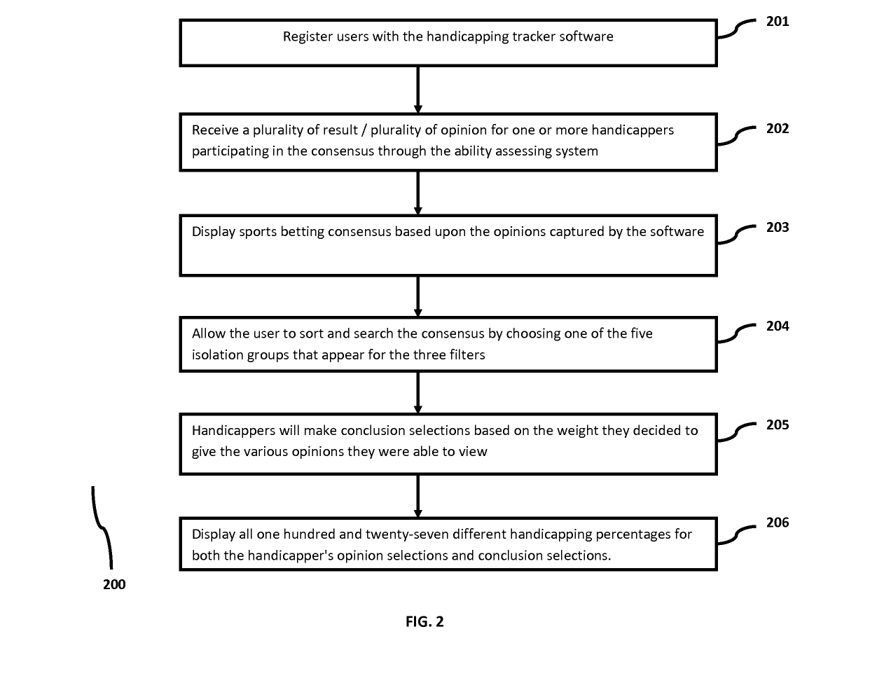

Referring to FIG. 2 illustrates a flow-chart 200 that explains the process of implementing the method for assessing the ability of each handicapper and determining the consensus of the game for the sports bettor(s) that can be searched and sorted by ability. Initially, at step 201, the method 200 allows the sport bettor(s) to register with the Handicapper tracking software 102. Upon successfully registering with the Handicapper tracking software 102, at step 202, the system 100 allows the user to provide a plurality of result / opinion as an input for each handicapper across six sports through a web interface associated with the Handicapper tracking software 102. At step 203, handicappers are tagged with one of the five ratings based on the ability in one hundred and twenty-seven handicapping categories. The software 102 then groups all handicappers with the same ratings together under the same filter. These are the fifteen different isolation pockets that can be spotlighted and extracted by the user. At step 204, the Handicapper tracking software 102 allows the user to sort and search the consensus based on the isolation groups created for the three filters. At step 205, the system is configured to determine in which of the five ratings any one handicapper lies across the three different filters: Overall, by Sport, and by game category. For example, user ABC is a handicapper that has an Overall win rate of 43%, a win rate in MLB (sport) of 54%, and a win rate in game category #17 in MLB of 50%, which makes the handicapper grouped WORST under the overall filter, GOOD under the sport filter, and AVERAGE in the particular game category. Further, the user will appear in three different groups across the three filters. In an embodiment, the system 100 is configured to determine in which ability rating each handicapper belongs to across the three filters: Overall, by Sport, and by game category. The ability rating scale is as follows: Best—57.5% win rate or higher—Good—57.4 to 54%—Average—53.9 to 50%—Below Avg—49.9 to 45—Worst—44.9 and below.

In an embodiment, with the ability tags associated with the handicappers, sports bettors are now able to separate the various ranges of ability that would appear in a general consensus. This allows the sports bettor to add weight to the opinion being made by any one group.

At step 206, the user is able to isolate any of the five ability ranges under the three different filters, which allows the sports bettor to generate a sub-set consensus using the opinions of the handicappers of a particular group. Further, the system 100 is configured to allow the user the ability to isolate any of the five ability ratings under each of the three filters and the information is immediately displayed to the user in a consensus format.

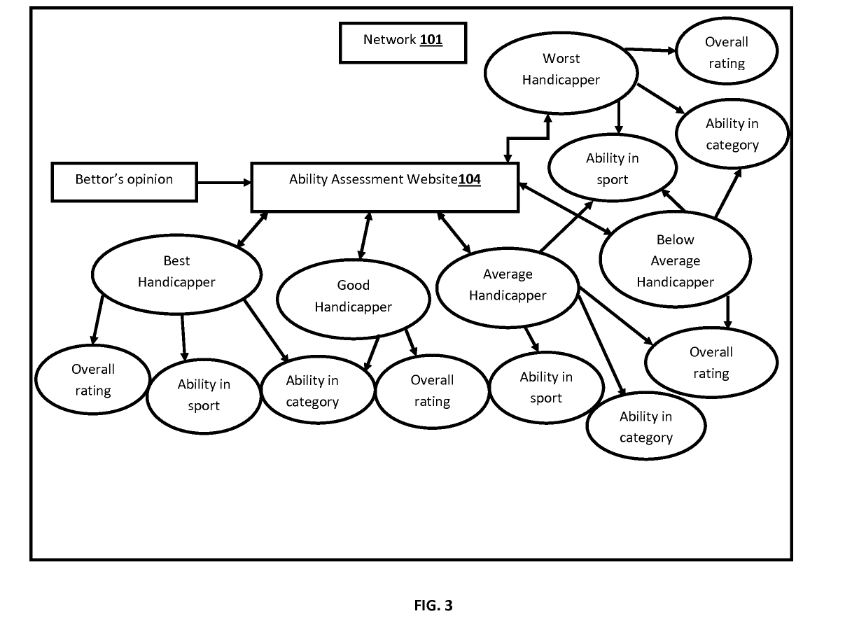

Referring to FIG. 3 illustrates the mode in which the opinions entered into the Handicapping tracker software 102 are turned into a plurality of consensuses to be viewed by the sports bettor. As depicted in the figure, the handicappers provide a plurality of opinion/a plurality of results to the handicapping tracker software 102 for assessing the ability. In an embodiment, the software 102 tags the handicappers with one of the five ratings in the one hundred and twenty-seven handicapping categories. Further, the same handicapper may appear in a different group across each of the three filters and the ability ratings is dependent on that handicapper's personal win rate either Overall, in a Sport, or in a game category. For example, User 123 has entered an Opinion of Dallas +5 in the sport of NBA and the user has a win rate of 56% overall, 49% in NBA, and 53% in NBA/Road/Underdogs of 3-6.5 points (this particular game category). The system would then group this handicapper as GOOD under the overall filter for this game, BELOW AVG for the sport filter for this game, and AVERAGE for the game category filter for this game. Further, the user can be a part of three different consensus based upon three different filters, where the handicapper appears with three different groups of peers.

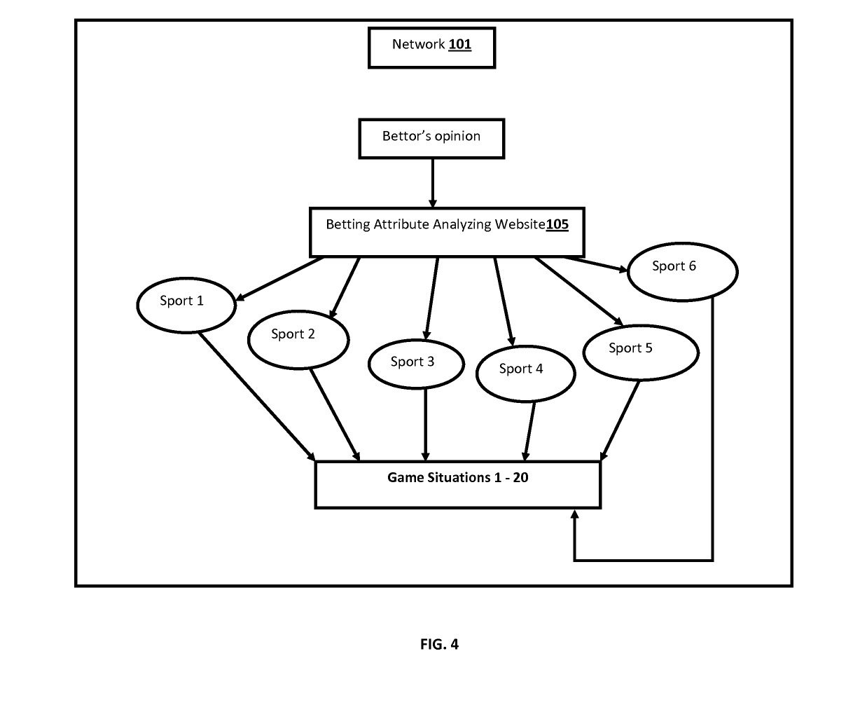

Referring to FIG. 4 illustrates a working overview of how the plurality of betting attributes is scored for each individual handicapper using an attribute analyzing software. As depicted in the figure, the handicappers enter opinions on various sports. Each sport has twenty different game situations that have been outlined by the attribute analyzer 105. The handicapper earns an individual win rate for each of the twenty categories in each of the six sports. For example, USER 123 can enter three NFL opinions: Dallas −7, San Diego +3, San Fran −2 and these three opinions fall under three different game categories. Further, the user can fall into three different groups depending on the win rate determined based on the game situations that is entered as an opinion in the attribute analyzer 105. Considering the specific game situations, the handicapper's opinion can now be analyzed appropriately using the tool.

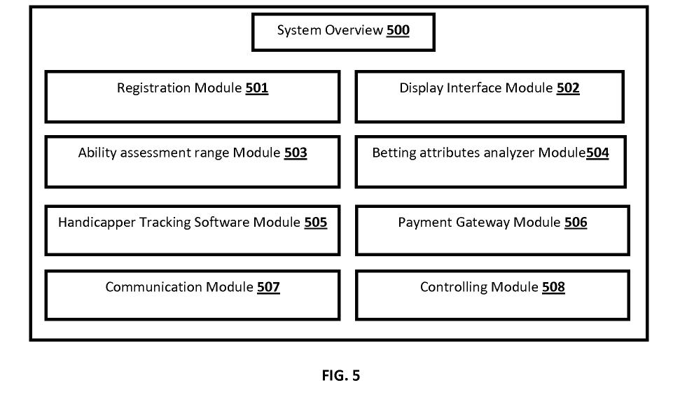

Referring to FIG. 5 illustrates a working overview 500 of components used to implement the method for assessing the ability of the handicapper, tag the handicapper with the appropriate ability rating, generate a sports betting consensus for the sports bettor, group the handicapper into the correct isolation consensus based on ability, and then display the data within the isolation consensus to the sports bettor. The system comprises of the following components: a Registration module 501, a Display Interface module 502, an Ability assessment module 503, an Attribute analyzer module 504, a Handicapper tracking software module 505, a Payment Gateway module 506, a Communication module 507, and a Controlling module 508. In an embodiment, the Registration module 401 is configured to register the handicappers with the Handicapper tracking software 102 with an intent to tag the handicapper in the proper isolation consensus for every game the handicapper enters an opinion. In an embodiment, the Display Interface module 502 is configured to capture the opinions of all the handicappers using the tool and to display these opinions using a sports betting consensus format. Further, the sports betting consensus isolates the sports bettor under fifteen different pockets within the entire betting pool of the game. In an embodiment, the Ability assessment range module 503 is configured to assess the ability of the handicappers who registers with the website and enters an opinion. In an embodiment, the attributes analyzer module 504 is configured to analyze the betting attributes of each handicapper. In an embodiment, the Handicapper tracking software module 505 is configured to track the opinion of every handicapper. Furthermore, the tracked opinion is used to generate a general sports betting consensus, which can be searched and sorted into fifteen separate isolation consensuses based on the ability of the handicapper. In an embodiment, the Payment Gateway module 506 is configured to supply payment details for the use of the isolation consensus based on the ability. In an embodiment, the Communication module 507 is configured to facilitate communication across various modules within the network 101. In an embodiment, the controlling module 508 is configured to transfer data across various modules used to implement the method.

1. A system for generating a sports betting consensus by determining the ability of at least one sports handicapper based upon the opinion entered into a Handicapping Tracker software, wherein the system is configured to:
receive a plurality of opinions / plurality of records across a plurality of handicappers through the Handicapping tracker software;
record the plurality of opinions / plurality of records in the Handicapping tracker software;
tag said plurality of handicappers with the appropriate rating in each of the one hundred and twenty seven different categories provided in a web interface of the Handicapping tracker software;
categorize said plurality of handicappers after tagging said plurality of handicappers with the appropriate rating; and
isolate consensus for said plurality of handicappers based on the category determined for said plurality of handicappers.

2. The system as claimed in claim 1, wherein said system is configured to receive said plurality of opinions/plurality of records across said plurality of handicappers through the Handicapping tracker software for either determining the opinion pick selected by a user or determining the consensus of the opinion pick selected by said user.

3. The system as claimed in claim 2, wherein said system is configured to display the original opinion of the handicapper and the conclusion of the handicappers through said Handicapping tracker software in each of the one hundred and twenty-seven categories.

4. The system as claimed in claim 1, wherein said isolated consensus can be searched and sorted based on the ability of the handicapper making the selection.

5. The system claimed in claim 1, wherein the system is configured to perform at least one function through said Handicapping tracker software:
register said at least one sports handicapper;
collect the opinion of said at least one sports handicapper;
assess the ability of said at least one handicapper; and
generate a sports betting consensus based on said plurality of opinions/plurality of records received from said at least one sports handicapper.

6. The system as claimed in claim 5, wherein the system comprises of the following components to perform said at least one function:
a means to receive said plurality of opinions/plurality of records entered into the tracker software for generating said sports betting consensus on a general public consensus.
a means to create a plurality of groups based on the ability assessment of said plurality of handicappers.
a means to determine a plurality of consensuses based on said plurality of groups after assessing the ability of said plurality of handicappers associated with said plurality of groups; and
a means to analyze a plurality of handicapping attributes for said at least one sports handicapper across a plurality of game situations.

7. The system as claimed in claim 6, wherein the system is configured to feed in said plurality of opinions/plurality of results to said Handicapping Tracker system to completely assess the ability of said at least one sports handicapper.

8. The system as claimed in claim 7, wherein the system is configured to assess the ability of said at least one sports handicapper considering a plurality of game situations.

9. The system as claimed in claim 1, wherein said system is configured to provide said sports betting consensus on said Handicapping tracker system that is associated with at least one feature such as a sorting feature, a searching feature, a filtering feature, or the like for displaying the assessed ability of said at least one sports handicapper.

10. The system as claimed in claim 6, wherein said system is configured to determine said plurality of consensus based on the range of ability assessed for said at least one sports handicapper.

11. The system as claimed in claim 1, wherein the system is configured to display the betting pool categorized into a plurality of ability ratings for said at least one sports handicapper for each of the factors categorizing the ability of said at least one sports handicapper based on a plurality of game situations.

12. A method for assessing the ability of at least one sports handicapper and generating the consensus of said sport for at least one bettor, wherein the method comprises of:
taking in a plurality of results/ plurality of opinions from said at least one sports handicapper in order to assess their ability in said game;
categorizing the ability of said at least one handicapper participating in said sport based on the following factors: Overall, Sport, Game Category;
displaying the betting pool that takes part in the consensus in a plurality of betting groups, which allows said at least one sports handicapper to add weight to the ability of the handicapper making the opinion across a plurality of game situations;
determining the winning percentage of said at least one sports handicapper that is able to add weight to the opinion(s) that exist in a plurality of consensuses for said sport; and
displaying the winning percentage of said at least one sports handicapper using the weightage of the ability determined for said at least one sports handicapper.

13. The method claimed in claim 12, wherein the method assesses the ability of said at least one sports handicapper and determines the consensus for at least one bettor whereby the method comprises of:
providing at least one feature that will assist the bettor with a plurality of consensuses by integrating the assessed ability with a general public consensus.
creating a plurality of ratings or groups based on the assessed ability of said at least one sports handicapper.
determining a plurality of consensuses based on a plurality of groups that assesses the ability of a plurality of handicappers associated with said plurality of groups.
analyzing the handicapping attributes of at least one bettor considering a plurality of game situations.

14. The method claimed in claim 12, wherein said method assesses the ability of said at least one sports handicapper by feeding in said plurality of opinion/plurality of results through said Handicapping Tracker Software.

15. The method as claimed in claim 12, wherein said method assesses the ability of said at least one sports handicapper considering a plurality of game situations.

16. The method as claimed in claim 12, wherein said method facilitates at least one feature to assist said at least one bettor to view said plurality of consensus through said general public consensus and said at least one feature comprises of a sorting feature, a searching feature, a filtering feature, or the like.

17. The method as claimed in claim 13, wherein said method determines said plurality of consensus based on the range of ability assessed for said at least one sports handicapper.

18. The method as claimed in claim 12, wherein said method displays a plurality of ability ratings for said at least one sports handicapper for each of the factors categorizing the ability of said at least one sports handicapper based on a plurality of game situations.
